(19) United States
(12) Patent Application Publication
(10) Pub. No.: US 2026/0010176 A1
(43) Pub. Date: Jan. 8, 2026

(54) SYSTEM AND METHOD FOR CALCULATING RELATIVE ANGLE OF DRIVEN ROBOT MECANICALLY COUPLED TO DRIVING ROBO

(71) Applicants: Hyundai Motor Company, Seoul (KR); Kia Corporation, Seoul (KR)

(72) Inventors: Dong Hwan Kwak, Hwaseong-Si (KR); Sanghyeon Oh, Hwaseong-Si (KR); Hyuntek Lim, Hwaseong-Si (KR)

(21) Appl. No.: 18/960,160

(22) Filed: Nov. 26, 2024

(30) Foreign Application Priority Data
Jul. 3, 2024 (KR) 10-2024-0087473

(51) Int. Cl. G05D 1/672; G05D 111/10

(52) U.S. Cl. CPC G05D 1/672; G05D 2111/10

(57) ABSTRACT

A system for controlling driving of a first robot is introduced. The system comprises the first robot configured to drive a second robot coupled to its rear side. The first robot's rear side is mechanically coupled to the second robot. A first sensor gathers sensor data for the second robot, and a second sensor captures a rear view image from the first robot, containing an image of the second robot. A processor determines a first angle between the robots based on sensor data, a second angle from the rear view image, and a third angle based on the first and second angles. The processor outputs a signal associated with the third angle and controls the first robot's driving based on this signal.

### CROSS-REFERENCE TO RELATED APPLICATION

This application claims the benefit of priority to Korean Patent Application No. 10-2024-0087473 filed in the Korean Intellectual Property Office on Jul. 3, 2024, the entire contents of which are incorporated herein by reference.

### TECHNICAL FIELD

The present disclosure relates to a system and a method for calculating a relative angle of a driven robot mechanically coupled to a driving robot.

### BACKGROUND

The matters described in this Background section are only for the enhancement of understanding of the background of the disclosure, and should not be taken as acknowledgment that they correspond to prior art already known to those skilled in the art.

Robots capable of autonomous driving may perform various tasks (e.g., charging of a vehicle parked in a parking lot) in addition to transporting people or cargo through autonomous driving.

Tasks performed by robots may include individual tasks performed by one robot alone and integrated tasks performed by several robots in cooperation. In order for a plurality of robots to perform integrated tasks, the plurality of robots may be mechanically connected, and only one of the plurality of robots may be driven. For example, a plurality of driven robots may be mechanically connected to a rear side of one driving robot. In this case, it is not difficult for the driving robot to move forward by pulling the plurality of driven robots, but it may be difficult for the driving robot to push backward by pushing the plurality of driven robots. For example, mechanical connecting means connecting the driving robot to the driven robot or connecting the driven robots to each other may be bent, and the driving robot and the driven robot may collide with each other. Accordingly, in order to move backward the driving robot and the driven robot which are mechanically connected, it is useful to detect a angle between the driving robot and the driven robot and control steering or posture of the driven robot according to the angle.

However, in the case of relatively small robots, it may be useful to develop a technology of detecting the angle between the driving robot and the driven robot, particularly by using sensors provided in the small robots capable of autonomous driving.

### SUMMARY

According to the present disclosure, a system for controlling driving of a first robot, the system may comprise, the first robot configured to drive a second robot, wherein a rear side of the first robot is configured to be mechanically coupled to the second robot, a first sensor configured to obtain sensor data for the second robot coupled to the rear side of the first robot, a second sensor configured to obtain a rear view image from the first robot, wherein the rear view image may comprise an image of the second robot coupled to the rear side of the first robot, and a processor configured to, determine, based on the sensor data, a first angle between the first robot and the second robot, determine, based on the rear view image, a second angle between the first robot and the second robot, determine, based on the first angle and the second angle, a third angle between the first robot and the second robot, output a signal associated with the third angle, and control, based on the signal, the driving of the first robot.

The system, wherein, the first sensor is configured to, acquire a shape of the second robot before the second robot is coupled to the first robot, and acquire a current shape of the second robot, and the processor is further configured to, move the first robot and the second robot straight forward to acquire a second shape of the second robot at a reference angle, determine whether the second shape of the second robot at the reference angle and the current shape of the second robot match, and determine, based on the shape of the second robot at the reference angle and the current shape of the second robot matching, the first angle.

The system, wherein the processor is further configured to output, based on the second shape of the second robot at the reference angle and the current shape of the second robot not matching, a signal indicating an angle determination failure.

The system, wherein the processor is further configured to, extract a feature point of the second robot from the rear view image, generate depth data of the feature point of the second robot, generate a depth map representing a depth data set based on the first angle by matching the first angle and the depth data of the feature point, and determine the second angle by comparing the depth data set with a current depth data set.

The system, wherein the processor is further configured to generate the depth map based on a number of the depth data set being greater than or equal to a threshold number of sets, and wherein the depth data set is collected for any initial angle.

The system, wherein the processor is further configured to output a Not Ready message based on the number of the depth data set being less than the threshold number of sets.

The system, wherein the processor is further configured to, move the first robot and the second robot straight forward, and separate the feature point of the second robot from a feature point of a surrounding environment of the second robot based on extracting the feature point of the second robot from the rear view image.

The system may further comprise, a third sensor configured to obtain a movement data of the first robot and the second robot, and a fourth sensor configured to obtain sensor data of an object in front of the first robot and the second robot, wherein the processor is configured to, determine a fourth angle between the first robot and the second robot based on, a local map storing a feature point of a surrounding environment, the movement data, the sensor data for the second robot, and the sensor data of the object, and determine, based on the fourth angle and the third angle, a final angle.

The system, wherein the processor is further configured to, obtain first absolute positions of the first robot and the second robot based on the sensor data for the second robot and the local map, obtain second absolute positions of the first robot and the second robot based on the movement data and the local map, and determine, based on the first absolute positions and the second absolute positions, the fourth angle.

The system, wherein the third sensor may comprise at least one of, an encoder provided in the first robot and the second robot and configured to measure information on a rotation of a wheel, and an inertial sensor provided in the first robot and the second robot and configured to measure information on a movement situation of the first robot and the second robot. The system, wherein the first robot is an autonomous moving robot.

According to the present disclosure, a method performed by a system for controlling driving of a first robot, the method may comprise, obtaining, from a first sensor, a sensor data for a second robot mechanically coupled to a rear side of the first robot, obtaining, from a second sensor, a rear view image from the first robot, wherein the rear view image may comprise an image of the second robot coupled to the rear side of the first robot, determining, based on the sensor data, a first angle between the first robot and the second robot, determining, based on the rear view image, a second angle between the first robot and the second robot, determining, based on the first angle and the second angle, a third angle between the first robot and the second robot, outputting a signal associated with the third angle, and controlling, based on the signal, driving of the first robot.

The method, wherein the determining the first angle may comprise, acquiring a shape of the second robot before the second robot is coupled to the first robot, moving the first robot and the second robot straight forward to acquire a second shape of the second robot at a reference angle, acquiring a current shape of the second robot, determining whether the second shape of the second robot at the reference angle and the current shape of the second robot match, and determining, based on the second shape of the second robot at the reference angle and the current shape of the second robot matching, the first angle.

The method, wherein the determining the first angle may comprise, outputting, based on the second shape of the second robot at the reference angle and the current shape of the second robot not matching, a signal indicating an angle determination failure.

The method, wherein the determining the second angle may comprise, extracting a feature point of the second robot from the rear view image, generating a depth data of the feature point of the second robot, generating a depth map representing a depth data set based on the first angle by matching the first angle and the depth data of the feature point, and determining the second angle by comparing the depth data set with a current depth data set.

The method, wherein the determining the second angle may comprise, generating the depth map based on a number of the depth data set being greater than or equal to a threshold number of sets, and wherein the depth data set is collected for any initial angle.

The method, wherein the determining the second angle may comprise, outputting a Not Ready message based on a number of the depth data set being less than a threshold number of sets, and wherein the depth data set is collected for any initial angle.

The method, wherein the extracting the feature point may comprise, moving the first robot and the second robot straight forward, and separating the feature point of the second robot from a feature point of a surrounding environment of the second robot.

The method may further comprise, obtaining, from a third sensor, a movement data of the first robot and the second robot, obtaining, from a fourth sensor, sensor data of an object in front of the first robot and the second robot, determining a fourth angle between the first robot and the second robot based on, a local map storing a feature point of a surrounding environment, the movement data, the sensor data for the second robot, and the sensor data of the object, and determining, based on the fourth angle and the third angle, a final angle.

The method, wherein the determining the fourth angle may comprise, obtaining first absolute positions of the first robot and the second robot based on the sensor data for the second robot and the local map, obtaining second absolute positions of the first robot and the second robot based on the movement data and the local map, and determining, based on the first absolute positions and the second absolute positions, the fourth angle.

In addition, the effects obtainable or predicted by the examples of the present disclosure are to be disclosed directly or implicitly in the detailed description of the examples of the present disclosure. That is, various effects predicted according to an example of the present disclosure will be disclosed in the detailed description to be described later.

### BRIEF DESCRIPTION OF THE DRAWINGS

Examples herein may be better understood with reference to the following description in connection with the accompanying drawings in which like reference numerals refer to identical or functionally similar elements.

FIG. 1 shows an example of a driving robot and a driven robot mechanically coupled to each other according to an example of the present disclosure.

FIG. 2 shows an example of a configuration of a robot (driving robot and/or driven robot) according to an example of the present disclosure.

FIG. 3 shows an example of a configuration of a processor according to an example of the present disclosure.

FIG. 4 shows an example of a configuration of a sensor system according to an example of the present disclosure.

FIG. 5 shows an example of a method of calculating a relative angle of a driven robot mechanically coupled to a driving robot according to an example of the present disclosure.

FIG. 6 is an exemplary detailed flowchart of step S100 of FIG. 5.

FIG. 7 shows an example of a driven robot of various shapes.

FIG. 8 shows an example of a shape of a driven robot detected by a light detection and ranging (LiDAR) of a driving robot.

FIG. 9 shows an example of a shape of a driven robot at a reference angle and a shape of the driven robot at a relative angle according to an example.

FIG. 10 shows an example in which calculation of a relative angle fails.

FIG. 11 is an exemplary detailed flowchart of step S200 of FIG. 5.

FIG. 12 is an exemplary detailed flowchart of step S300 of FIG. 5.

It should be understood that the drawings referenced above are not necessarily drawn to scale, but present a rather simplified representation of various preferred features illustrating the basic principle of the present disclosure. For example, specific design features of the present disclosure including, for example, specific sizes, directions, positions, and shapes, are determined in part according to specifically intended applications and environments of use.

### DETAILED DESCRIPTION

The terms used herein are for the purpose of describing specific examples only, and are not intended to limit the present disclosure. As used herein, singular forms are intended to also include plural forms unless the context clearly indicates otherwise. It will also be understood that the terms “comprises” and/or “comprising” when used herein, specify the presence of mentioned features, integers, steps, actions, elements and/or components, but do not exclude the presence or addition of one or more of other features, integers, steps, actions, elements, components, and/or groups thereof. As used herein, the term “and/or” includes any one or all combinations of the associated listed items.

For purposes of this application and the claims, using the exemplary phrase “at least one of: A; B; or C” or “at least one of A, B, or C,” the phrase means “at least one A, or at least one B, or at least one C,” or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “robots” or other similar terms used herein include general robots capable of moving on land including passenger cars including sports utility vehicles (SUVs), buses, trucks, various commercial vehicles, etc., robots capable of moving on the sea including various boats and ships, and robots capable of moving on the air including aircraft, drones, etc., and include any object capable of moving by receiving power from a power source. In addition, the term “robots” or other similar terms used herein are understood to include hybrid powered robots, electric powered robots, plug-in hybrid powered robots, hydrogen powered robots, and other alternative fuel (e.g., fuel derived from resources other than petroleum) robots. As mentioned herein, hybrid powered robots include robots with two or more power sources, such as gasoline powered and electric power robots. A robot according to an example of the present disclosure includes not only a manually driven robot but also a robot that is somewhat autonomously and/or automatically driven. For example, a robot may be an autonomous driving vehicle. An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering. acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of integrated angles between a driving robot and a driven robot coupled to the driving robot) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of integrated angles between a driving robot and a driven robot coupled to the driving robot) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of integrated angles between a driving robot and a driven robot coupled to the driving robot) described herein.

Minimum risk maneuver (MRM) operation(s) may also be controlled, for example, based on one or more features (e.g., features of integrated angles between a driving robot and a driven robot coupled to the driving robot) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of integrated angles between a driving robot and a driven robot coupled to the driving robot) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of integrated angles between a driving robot and a driven robot coupled to the driving robot) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

Additionally, it is understood that one or more of the methods below or examples thereof may be executed by at least one or more controllers. The term “controller” may refer to a hardware device (e.g., circuit, circuitry, application specific integrated circuit (ASIC), etc.) including a memory and a processor. The memory is configured to store program instructions, and the processor is specifically programmed to execute the program instructions to perform one or more processes described in more detail below. A controller may control operations of units, modules, parts, devices, or similar thereto, as described herein. It is also understood that the methods below may be performed by a device including a controller along with one or more other components, as will be appreciated by those skilled in the art.

In addition, the controller of the present disclosure may be implemented as a non-transitory computer-readable recording medium including executable program instructions executed by a processor. Examples of computer-readable recording media include ROM, RAM, compact disk (CD) ROM, magnetic tapes, floppy disks, flash drives, smart cards, and optical data storage devices, but are not limited thereto. The computer-readable recording medium may also be distributed throughout a computer network so that program instructions may be stored and executed in a distributed manner, for example, in a telematics server or a controller area network (CAN).

Hereinafter, examples of the present disclosure will be described in detail with reference to the accompanying drawings. According to the present disclosure, an estimated angle between an autonomous vehicle (e.g., a driving robot, a compact autonomous mobility devices) and a mechanically coupled rear device (e.g., a driven robot) may be improved without adding extra sensors. By leveraging sensors like a camera and LiDAR, the stability and accuracy of the estimated angle may be enhanced. The driven robot follows the driving robot's movements and orientation and may rely on accurate angle estimation to ensure proper alignment and control, especially during complex maneuvers like reversing. According to the present disclosure, an angle between the driving robot and the driven robot is estimated to maintain stability and control during these maneuvers. The driven robot may rely on sensors such as LiDAR and a camera on the driving robot to achieve this alignment without additional sensors on itself. This setup may allow the driven robot to function as an extension of the driving robot, enhancing coordinated movement and docking capabilities.

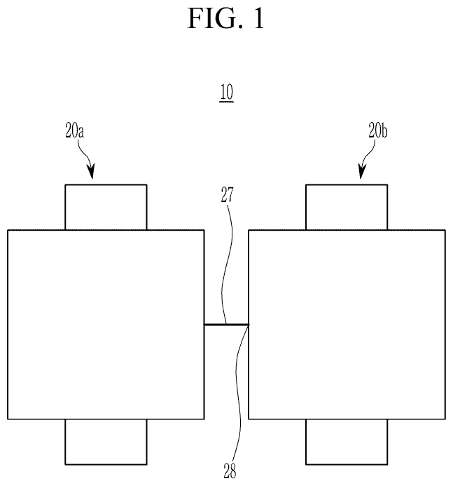

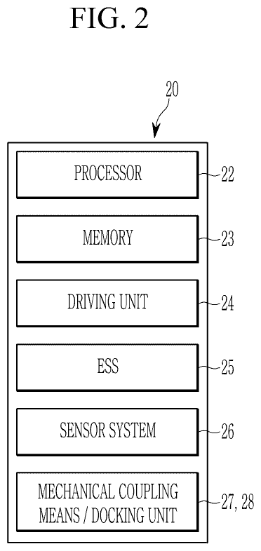

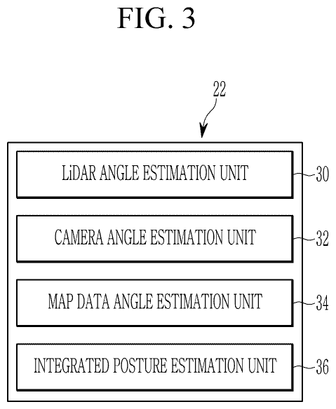

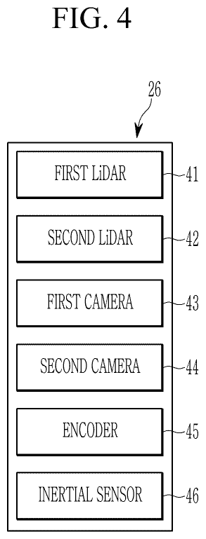

FIG. 1 shows an example of a driving robot and a driven robot mechanically coupled to each other according to an example of the present disclosure; FIG. 2 shows an example of a configuration of a robot (driving robot and/or driven robot) according to an example of the present disclosure; FIG. 3 shows an example of a configuration of a processor according to an example of the present disclosure; and FIG. 4 shows an example of a configuration of a sensor system according to an example of the present disclosure.

As shown in FIG. 1, a system 10 of calculating a relative angle of a driven robot mechanically coupled to a driving robot according to an example of the present disclosure may include a plurality of robots 20 communicatively coupled to each other. The plurality of robots 20 may include at least one driving robot 20a and at least one driven robot 20b, and the at least one driving robot 20a and the at least one driven robot 20b or a plurality of driven robots 20b are mechanically coupled to each other. Here, the driving robot 20a refers to the robot 20 that provides a driving force of an integrated robot mechanically coupled to the driven robot 20b and controls an operation of the integrated robot, and the driven robot 20b refers to the robot 20 that operates according to the driving force and the control of the driving robot 20a while integrated with the driving robot 20a. For example, the driving robot 20a may control a mechanical connection with the driven robot 20b, provide the driving force to the driving robot 20a and the driven robot 20b, and control the operations of the driving robot 20a and the driven robot 20b. In addition, the driven robot 20b may control its own operation without being integrated with the driving robot 20a, but may operate according to the driving force and the control of the driving robot 20a when integration with the driving robot 20a is requested or while integrated with the driving robot 20a.

Mechanical coupling means 27 may be provided to one of the driving robot 20a and the driven robot 20b or one of the two driven robots 20b adjacent to each other, a docking unit 28 may be provided to the other of the driving robot 20a and the driven robot 20b or the other of the two driven robots 20b adjacent to each other, and the mechanical coupling means 27 and the docking unit 28 may be mechanically coupled to or separated from each other. Here, the mechanical coupling means 27 may be a hook, a joint, a chain, a hitch ball, etc., but a type of the mechanical coupling means 27 is not particularly limited, and the docking unit 28 may be coupling means corresponding to the mechanical coupling means 27.

Hereinafter, a configuration of the driving robot 20a or the driven robot 20b will be described in more detail with reference to FIG. 2.

As shown in FIG. 2, the robot 20 (driving robot 20a or driven robot 20b) includes a processor 22, a memory 23, a driving unit 24, an energy storage system (ESS) 25, a sensor system 26, the mechanical coupling means 27, and the docking unit 28.

The processor 22 is provided to the robot 20 and controls the overall operation of the robot 20. For example, the processor 22 may communicate with the processor 22 of another robot 20 and transmit/receive a control command to/from another robot 20. Also, the processor 22 may receive a driver input through a user interface. The processor 22 may control the driving unit 24, the ESS 25, the sensor system 26, the mechanical coupling means 27, the docking unit 28, or the processor 22 of another robot 20 in response to receiving the control command of another robot 20 or the driver input through the user interface. In addition, the processor 22 may receive a state of another robot 20 from the processor 22 of the corresponding robot 20. In response to receiving the state of another robot 20, the processor 22 may display the state of another robot 20 on the user interface or control the operation of the corresponding robot 20 and/or another robot 20 based on the state of another robot 20 and the control command/driver input.

As described above, the control command/driver input may include at least one of a coupling command/input for coupling one robot 20 with another robot 20, a separation command/input for separating one robot 20 from another robot 20, a charging command/input, a movement command/input for moving to a destination, and/or a command/input for a task. The coupling command/input may include information about another robot 20 (e.g., identification information of another robot 20, a position of another robot 20, etc.), identification information of the mechanical coupling means 27 to be used, etc., and the separation command/input may include information about the robot 20 to be separated, etc. The charging command/input may include information about a position of a charging station or a route to the charging station, a state of charge (SOC) to be charged, etc. The movement command/input may include information about a position of the destination, information about a route to the destination, information about an SOC required for moving to the destination, etc.

In addition, the state of the robot 20 may include at least one of the position of the robot 20, an SOC of the ESS 25 within the robot 20, a task of the robot 20, whether the robot 20 is autonomously driving, and a route on which the robot 20 is moving.

Additionally, the processor 22 is configured to perform each step of a method of calculating a relative angle of the driven robot 20b mechanically coupled to the driving robot 20a according to an example of the present disclosure. To this end, as shown in FIG. 3, the processor 22 includes a light detection and ranging (LiDAR) angle estimation unit 30, a camera angle estimation unit 32, a map data angle estimation unit 34, and an integrated posture estimation unit 36.

The LiDAR angle estimation unit 30 is configured to calculate a relative angle of the driven robot 20b mechanically coupled to the driving robot 20a based on a LiDAR data detected by the sensor system 26.

The camera angle estimation unit 32 is configured to calculate a relative angle of the driven robot 20b mechanically coupled to the driving robot 20a based on an image of the driven robot 20b detected by the sensor system 26.

The map data angle estimation unit 34 is configured to calculate a relative angle of the driven robot 20b mechanically coupled to the driving robot 20a by using the LiDAR data detected by the sensor system 26, movement data, and a local map.

The integrated posture estimation unit 36 is configured to calculate a final relative angle by integrating the relative angle calculated by the LiDAR angle estimation unit 30 and the relative angle calculated by the camera angle estimation unit 32. Selectively, the integrated posture estimation unit 36 is configured to the final relative angle by further integrating the relative angle calculated by the map data angle estimation unit 34. In addition, the integrated posture estimation unit 36 is further configured to output the calculated final relative angle to a component that requires the relative angle.

Referring back to FIG. 2, the memory 23 is configured to store a program command to allow the processor 22 to perform each step of the method of calculating the relative angle of the driven robot 20b mechanically coupled to the driving robot 20a according to an example of the present disclosure. The local map for detecting absolute positions of the driving robot 20a and the driven robot 20b may be further stored in the memory 23.

The driving unit 24 is mounted on the robot 20 and receives power from the ESS 25 to move the robot 20. The driving unit 24 may include, but is not limited to, at least one wheel and at least one driving motor connected to the at least one wheel to rotate the at least one wheel. The driving unit 24 may further include a steering device steering the robot 20.

The ESS 25 may be mounted in the robot 20, and receive and store electrical energy from the charging station or discharge the electrical energy by the control of the processor 22 to drive the driving unit 24.

The sensor system 26 may detect information for the state of the robot 20, autonomous movement, or mechanical connection with another robot 20, and transmit the information to the processor 22. In response to receiving the information, the processor 22 may transmit the information to another robot 20 or control the autonomous movement or the mechanical connection with another robot 20 based on the information. The information may include, but is not limited to, the position, a speed, an acceleration, a posture, or the SOC of the robot 20.

In addition, the sensor system 26 is further configured to detect various data for calculating the relative angle between the driving robot 20a and the driven robot 20b mechanically coupled to control driving of the robot 20. To this end, as shown in FIG. 4, the sensor system 26 includes first and second LiDARs 41 and 42, first and second cameras 43 and 44, an encoder 45, and an inertial sensor 46.

The first LiDAR 41 may be mounted on the robot 20, irradiate a laser pulse to the front of the robot 20 and then, measure the time it takes for the laser pulse reflected from an object within a field of view of the first LiDAR 41 to return, and detect information about the object such as a distance from the robot 20 to the object, a direction to the object, a speed, a temperature, a material distribution, concentration characteristics of the object, etc. Here, the object may be another robot, person, object, etc. existing outside the robot 20 on which the first and second LiDARs 41 and 42 are mounted, but a type of object is not particularly limited in the present disclosure. The first LiDAR 41 may be connected to the processor 22 to detect the LiDAR data of the object (e.g., a plurality of feature points included in the object) in front of the robot 20, and transmit the LiDAR data of the object in front of the robot 20 to the processor 22. The processor 22 may control forward driving of the robot 20 based on the LiDAR data of the object in front of the robot 20 received from the first LiDAR 41.

The second LiDAR 42 may be mounted on the robot 20 and detect information about an object in the rear of the robot 20 by irradiating a laser pulse to the rear of the robot 20. Here, the information about the object in the rear of the robot 20 may include a LiDAR data related to a shape of the driven robot 20b. The second LiDAR 42 may detect the LiDAR data related to the shape of the driven robot 20b and transmit the LiDAR data related to the shape of the driven robot 20b to the processor 22. The processor 22, particularly the LiDAR angle estimation unit 30, may calculate a first relative angle of the driven robot 20b based on the LiDAR data related to the shape of the driven robot 20b received from the second LiDAR 42.

The first camera 43 is mounted on the robot 20 and obtains a front image of the robot 20 within a field of view of the first camera 43. The first camera 43 may be connected to the processor 22 and transmit the obtained front image of the robot 20 to the processor 22. The processor 22 may search for the object in the image through an object search algorithm based on the front image of the robot 20 received from the first camera 43, and control the forward driving of the robot 20 based on the found object and the local map.

The second camera 44 is mounted on the robot 20 and obtains a rear image of the robot 20 within a field of view of the second camera 44. The second camera 44 may be connected to the processor 22 and transmit the obtained rear image of the robot 20 to the processor 22. The processor 22, particularly the camera angle estimation unit 32, may extract a feature point of the object, particularly the driven robot 20b, in the rear image through the object search algorithm based on the rear image of the robot 20 received from the second camera 43 and calculate a second relative angle based on the feature point of the driven robot 20b.

The encoder 45 measures information about rotation of the driving motor or the wheel provided in the robot 20. The encoder 45 may be connected to the processor 22 to transmit the measured information about the rotation of the driving motor or the wheel to the processor 22. The processor 22 may calculate the movement data of the robot 20, such as a moving speed and/or a moving distance of the robot 20, based on the information about the rotation of the driving motor or the wheel.

The inertial sensor 46 measures information about a movement situation of the robot 20, including the speed, direction, gravity, and the acceleration of the robot 20. The inertial sensor 46 may be connected to the processor 22 to transmit the measured information about the movement situation of the robot 20 to the processor 22. The processor 22 may detect or supplement the movement data of the robot 20 based on the information about the movement situation of the robot 20.

Here, it is shown that both the encoder 45 and the inertial sensor 46 are used as a movement data sensor detecting the movement data of the robot 20, but only one of the encoder 45 and the inertial sensor 46 may be used as the movement data sensor. In addition, the movement data sensor is not limited to the encoder 45 and the inertial sensor 46, and may include various sensors detecting the movement data of the robot 20.

The map data angle estimation unit 34 is configured to obtain the LiDAR data related to the shape of the driven robot 20b received from the second LiDAR 42 and first absolute positions of the driving robot 20a and the driven robot 20b by using the local map. In addition, the map data angle estimation unit 34 is further configured to detect the movement data of the robot 20 based on the information about the rotation of the driving motor or the wheel received from the encoder 45 or the information about the movement situation of the robot 20 received from the inertial sensor 46 and obtain second absolute positions of the driving robot 20a and the driven robot 20b by using the movement data of the robot 20 and the local map.

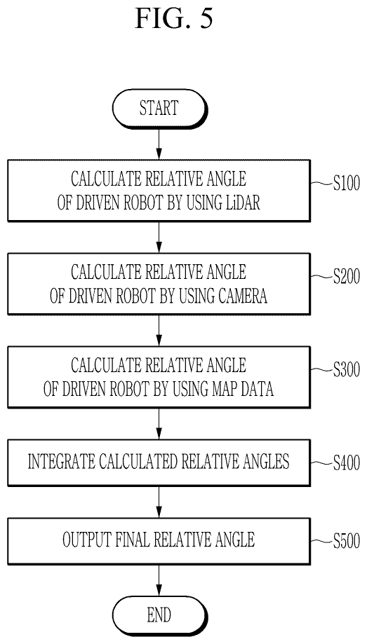

Hereinafter, a method of calculating a relative angle of a driven robot mechanically coupled to a driving robot according to an example of the present disclosure will be described in detail with reference to FIGS. 5 to 12.

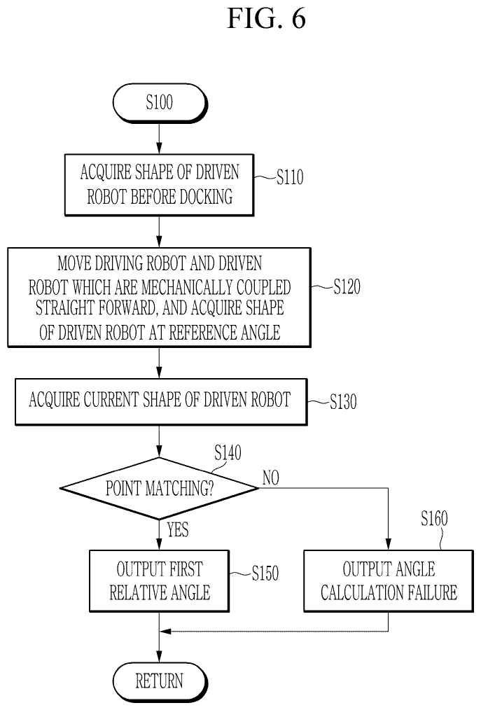

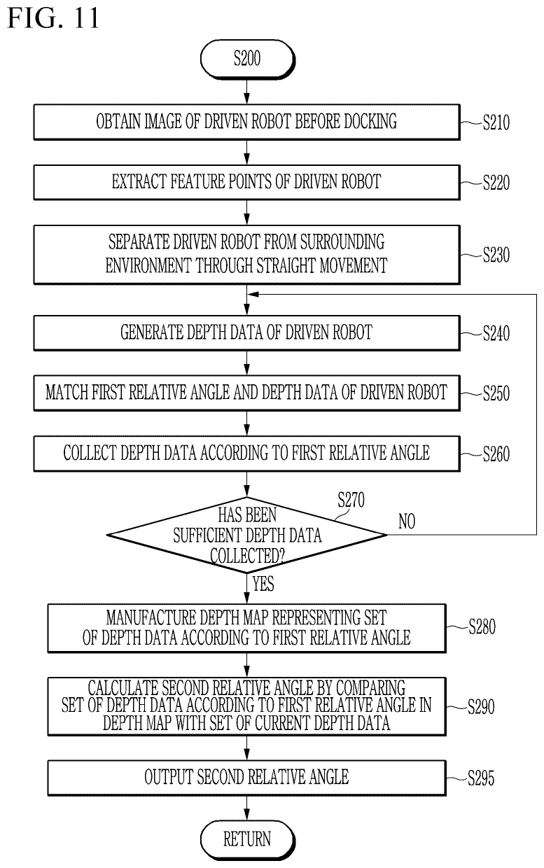

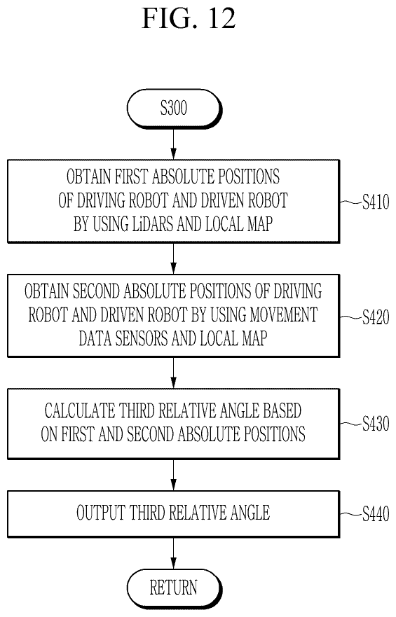

For convenience, FIG. 5, FIG. 6, FIG. 11, and FIG. 12 are described by way of an example in which the steps are performed by a processor (e.g., control circuitry). One, some, or all steps of FIG. 5, FIG. 6, FIG. 11, and FIG. 12, or portions thereof, may be performed by one or more other circuits. One or some, steps of FIG. 5, FIG. 6, FIG. 11, and FIG. 12 may be omitted, performed in other orders, and/or otherwise modified, and/or one or more additional steps may be added.

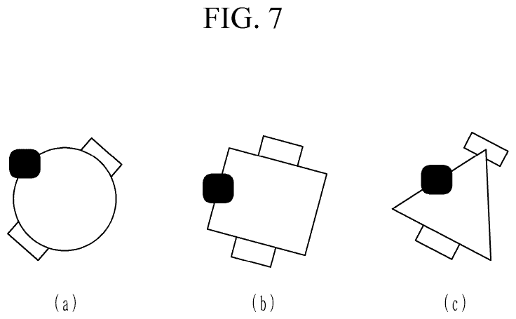

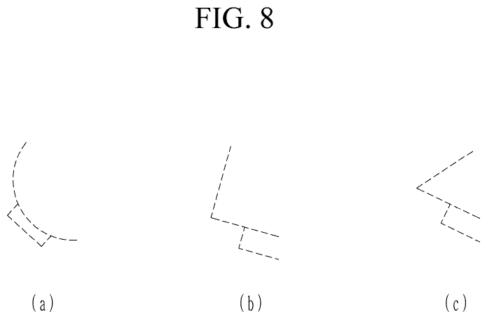

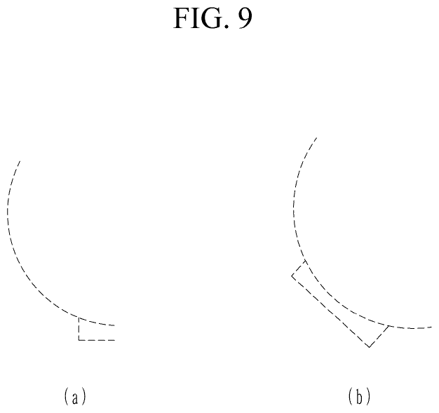

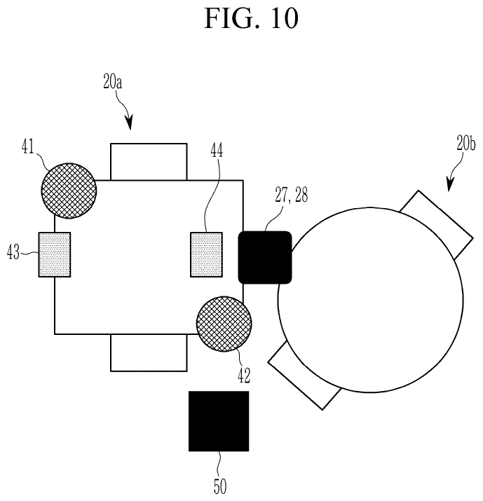

FIG. 5 shows an example of a method of calculating a relative angle of a driven robot mechanically coupled to a driving robot according to an example of the present disclosure; FIG. 6 is an exemplary detailed flowchart of step S100 of FIG. 5; FIG. 7 shows an example of a driven robot of various shapes; FIG. 8 shows an example of a shape of a driven robot detected by a LiDAR of a driving robot; FIG. 9 shows an example of a shape of a driven robot at a reference angle and a shape of the driven robot at a relative angle according to an example; FIG. 10 shows an example in which calculation of a relative angle fails; FIG. 11 is an exemplary detailed flowchart of step S200 of FIG. 5; and FIG. 12 is an exemplary detailed flowchart of step S300 of FIG. 5.

As shown in FIG. 5, the method of calculating the relative angle of the driven robot mechanically coupled to the driving robot according to the example of the present disclosure includes step S100 of calculating the relative angle of the driven robot 20b by using the LiDAR and step S200 of calculating the relative angle of the driven robot 20b by using the camera.

As shown in FIG. 6, the step S100 of calculating the relative angle of the driven robot 20b by using the LiDAR starts when the second LiDAR 42 acquires the LiDAR data related to the shape of the driven robot 20b before the driven robot 20b is docked to the driving robot 20a in step S110. Here, one side of the driving robot 20a to which the driven robot 20b is coupled is referred to as a rear side or the rear, and the other side of the driving robot 20a is referred to as a front side or the front. In addition, ‘detecting the LiDAR data related to the shape of the driven robot 20b’ will be expressed as ‘acquiring the shape of the driven robot 20b’ or similarly. As shown in FIG. 7, the driven robots 20b of various shapes may be coupled to the driving robot 20a. For example, the circular driven robot 20b is shown in (a) of FIG. 7, the rectangular driven robot 20b is shown in (b) of FIG. 7, and the triangular driven robot 20b is shown in (c) of FIG. 7. However, the shape of the driven robot 20b is not limited to the shapes shown in FIG. 7.

In addition, instead of acquiring the entire shape of the driven robot 20b, the second LiDAR 42 may acquire only the shape of the driven robot 20b adjacent to the mechanical coupling means 27 or the docking unit 28. For example, (a) of FIG. 8 shows the second LiDAR 42 having acquired the shape of the driven robot 20b shown in (a) of FIG. 7, (b) of FIG. 8 shows the second LiDAR 42 having acquired the shape of the driven robot 20b shown in (b) of FIG. 7, and (c) of FIG. 8 shows the second LiDAR 42 having acquired the shape of the driven robot 20b shown in (c) of FIG. 7.

When the shape of the driven robot 20b is acquired in the step S110, the processor 22 of the driving robot 20a and/or the processor 22 of the driven robot 20b controls the mechanical coupling between the driving robot 20a and the driven robot 20b. For example, the driving unit 24 of the driving robot 20a and/or the driving unit 24 of the driven robot 20b are controlled to move the driving robot 20a and/or the driven robot 20b toward each other, and the mechanical coupling means 27 and the docking unit 28 are controlled to be coupled to each other.

When the driving robot 20a and the driven robot 20b are mechanically coupled to each other, the processor 22 of the driving robot 20a moves the driving robot 20a and the driven robot 20b which are mechanically coupled straight forward, and the second LiDAR 42 acquires the shape of the driven robot 20b at a reference angle in step S120. When the driving robot 20a and the driven robot 20b which are mechanically coupled are moved straight forward, the driving robot 20a and the driven robot 20b are aligned in a traveling direction, and the relative angle between the driving robot 20a and the driven robot 20b is 0°. Therefore, while the driving robot 20a and the driven robot 20b which are mechanically coupled are moved straight forward, the second LiDAR 42 acquires the shape (see (a) of FIG. 9) of the driven robot 20b at the reference angle (the relative angle of 0°).

While the shape of the driven robot 20b is acquired at the reference angle, the second LiDAR 42 acquires a current shape of the driven robot 20b in step S130. In response to the processor 22 of the driving robot 20a determining that it is necessary to move the driving robot 20a and the driven robot 20b which are mechanically coupled backward, the second LiDAR 42 acquires the current shape (see (b) of FIG. 9) of the driven robot 20b.

When the current shape of the driven robot 20b is acquired, the processor 22 of the driving robot 20a performs matching between the shape of the driven robot 20b at the reference angle and the current shape of the driven robot 20b through a point matching algorithm. Here, the point matching algorithm may be, but is not limited to, an interactive closed point (ICP) algorithm.

Thereafter, the processor 22 of the driving robot 20a determines whether the shape of the driven robot 20b at the reference angle and the current shape of the driven robot 20b match with each other in step S140. If the shape of the driven robot 20b at the reference angle and the current shape of the driven robot 20b match with each other (“Yes” in the step S140), the first relative angle between the driving robot 20a and the driven robot 20b is output to the integrated posture estimation unit 36 of the driving robot 20a in step S150.

On the contrary, if the shape of the driven robot 20b at the reference angle and the current shape of the driven robot 20b do not match with each other (“No” in the step S140), the processor 22 of the driving robot 20a outputs an angle calculation failure signal indicating that ‘the relative angle cannot be calculated’ to the integrated posture estimation unit 36 in step S160. For example, as shown in FIG. 10, if an obstacle 50 is located close to the driven robot 20b within a field of view of the second LiDAR 42, the shape of the driven robot 20b at the reference angle and the current shape of the driven robot 20b do not match with each other. In this case, the first relative angle is not considered when calculating the final relative angle by outputting the angle calculation failure signal indicating that ‘the relative angle cannot be calculated’ to the integrated posture estimation unit 36.

Also, the processor 22 of the driving robot 20a calculates the relative angle of the driven robot 20b by using the camera in the step S200. As shown in FIG. 11, the step S200 of calculating the relative angle of the driven robot 20b by using the camera starts in step S210. Before the driven robot 20b is docked to the driving robot 20a, the second camera 44 obtains the image of the driven robot 20b in the step S210. For example, the second camera 44 obtains the image of the driven robot 20b to be coupled to the rear side of the driving robot 20a together with a surrounding environment by photographing the image of the rear of the driving robot 20a. In this case, instead of acquiring the entire image of the driven robot 20b, the second camera 44 may acquire only the image of the driven robot 20b adjacent to the mechanical coupling means 27 or the docking unit 28.

When the second camera 44 obtains the image of the driven robot 20b, the obtained image of the driven robot 20b is transmitted to the processor 22 of the driving robot 20, particularly the camera angle estimation unit 32, and the camera angle estimation unit 32 extracts the feature points of the driven robot 20b in the image of the driven robot 20b through the object search algorithm in step S220. As described above, because the image of the driven robot 20b also includes an image of the surrounding environment, the feature points of the driven robot 20b may also include feature points of the surrounding environment.

When the feature points of the driven robot 20b are extracted, the processor 22 of the driving robot 20 moves the driving robot 20a and the driven robot 20b which are mechanically coupled straight forward through the driving unit 24 of the driving robot 20, and the camera angle estimation unit 32 separates the feature points of the driven robot 20b from the feature points of the surrounding environment in step S230. For example, when the driving robot 20a and the driven robot 20b which are mechanically coupled are moved straight forward, because the relative posture of the driving robot 20a and the driven robot 20b which are mechanically coupled does not change, the actual feature points of the driven robot 20b remain unchanged, while the feature points of the surrounding environment change because the relative position of the surrounding environment with the driving robot 20a changes. Therefore, the actual feature points of the driven robot 20b may be separated from the feature points of the surrounding environment by extracting the feature points that remain unchanged among the feature points extracted in the step S220.

When the actual feature points of the driven robot 20b are separated, the camera angle estimation unit 32 generates depth data of the actual feature points in step S240 and measures the relative position of the driven robot 20b with respect to the driving robot 20a.

When the depth data of the actual feature points is generated, the camera angle estimation unit 32 receives the first relative angle for the current state of the driven robot 20b from the LiDAR angle estimation unit 30, matches the first relative angle with the depth data of the actual feature points in step S250, and collects the depth data of the actual feature points according to the first relative angle in step S260.

Thereafter, the camera angle estimation unit 32 determines whether sufficient depth data has been collected in step S270. When the steps S250 and S260 are performed, a depth data set for one first relative angle is generated, and in the step S270, it is determined whether the number of depth data sets collected for any first relative angle is equal to or greater than a predetermined number of sets.

If it is determined that the sufficient depth data has been collected in the step S270 (e.g., when the number of depth data sets collected for any first relative angle is greater than the predetermined number of sets), the camera angle estimation unit 32 outputs a “Ready” message or a similar message to the integrated posture estimation unit 36 and generates a depth map representing the depth data set according to the first relative angle in step S280, and if it is determined that the sufficient depth data has not been collected in the step S270 (e.g., if the number of depth data sets collected for any first relative angle is less than the predetermined number of sets), the camera angle estimation unit 32 outputs a “Not Ready” message or a similar message to the integrated posture estimation unit 36, returns to the step S240, and repeats the steps S240 to S270.

When the depth map is generated, the camera angle estimation unit 32 calculates the second relative angle by comparing the depth data set according to the first relative angle in the depth map with a current depth data set in step S290. For example, the camera angle estimation unit 32 compares the depth data set according to the first relative angle in the depth map with the current depth data set through the point matching algorithm, and calculates the second relative angle through the comparison. Here, the point matching algorithm may be, but is not limited to, an ICP algorithm.

Thereafter, the camera angle estimation unit 32 outputs the calculated second relative angle to the integrated posture estimation unit 36 in step S295.

Referring back to FIG. 5, the method of calculating the relative angle of the driven robot mechanically coupled to the driving robot according to the example of the present disclosure may optionally further include step S300 of calculating the relative angle of the driven robot 20b by using the map data. The step S300 is to improve the accuracy of relative angle calculation, and may be advantageously used in a static environment where the absolute positions of the driving robot 20a and the driven robot 20b may be accurately detected.

As shown in FIG. 12, the step S300 of calculating the relative angle of the driven robot 20b by using the map data starts by obtaining the first absolute positions of the driving robot 20a and the driven robot 20b by using the first and second LiDARs 41 and 42 and the local map in step S410. Here, the local map is a map provided for localizing the robot 20, and stores the feature points of the surrounding environment. For example, the map data angle estimation unit 34 obtains the first absolute position of the driving robot 20a and the first absolute position of the driven robot 20b by using the LiDAR data measured by the first and second LiDARs 41 and 42 and the local map through a localization algorithm.

In addition, the map data angle estimation unit 34 obtains the second absolute positions of the driving robot 20a and the driven robot 20b by using the movement data sensors 45 and 46 and the local map in step S420. For example, the encoder 45 and/or the inertial sensor 46 of the driving robot 20a and the driven robot 20b detect(s) the movement data such as the moving distance and/or a moving direction of each robot 20, and obtain(s) the second absolute position of the driving robot 20a and the second absolute position of the driven robot 20b by using the detected movement data and the local map.

When the first and second absolute positions of the driving robot 20a and the first and second absolute positions of the driven robot 20b are obtained, the map data angle estimation unit 34 calculates a third relative angle based on the first and second absolute positions of the driving robot 20a and the driven robot 20b in step S430. For example, the map data angle estimation unit 34 integrates the first and second absolute positions of the driving robot 20a and the first and second absolute positions of the driven robot 20b through a filter such as a Kalman filter, a low pass filter, etc. to calculate a final absolute position of the driving robot 20a and a final absolute position of the driven robot 20b, and calculates the third relative angle based on the final absolute position of the driving robot 20a and the final absolute position of the driven robot 20b.

Thereafter, the map data angle estimation unit 34 outputs the calculated third relative angle to the integrated posture estimation unit 36 in step S440.

Referring back to FIG. 5, the method of calculating the relative angle of the driven robot mechanically coupled to the driving robot according to the example of the present disclosure further includes step S400 of integrating the calculated relative angles and step S500 of outputting a final relative angle.

The integrated posture estimation unit 36 inputs the first relative angle received from the LiDAR angle estimation unit 30, the second relative angle received from the camera angle estimation unit 32, and/or the third relative angle received from the map data angle estimation unit 34 into the filter such as the Kalman filter, the low pass filter, etc. to integrate the first, second, and third relative angles. Thereafter, the integrated posture estimation unit 36 outputs the final relative angle to the component that requires the relative angle, for example, the processor 22 of the driven robot 20b, for posture control of the driven robot 20b in the step S500.

In the present specification, it has been described that the processor 22 of the driving robot 20a performs the method, but a subject performing the method is not limited thereto. It should be understood that the subject performing the method may be the processor 22 of the driven robot 20b or a remote control server.

The present disclosure attempts to provide a system and a method for calculating a relative angle of a driven robot mechanically coupled to a driving robot by using a light detection and ranging (LiDAR) and a camera provided to the driving robot.

According to an example of the present disclosure, a system for calculating a relative angle of a driven robot mechanically coupled to a driving robot is provided. The driven robot is capable of being mechanically coupled to a rear side of the driving robot.

The system includes a light detection and ranging (LiDAR) configured to detect a LiDAR data for the driven robot on the rear side of the driving robot; a camera configured to detect a rear image of the driving robot including the driven robot on the rear side of the driving robot; and a processor configured to calculate a first relative angle of the driven robot based on the LiDAR data for the driven robot, calculate a second relative angle of the driven robot based on the rear image of the driving robot including the driven robot and the first relative angle, and calculate a final relative angle by integrating the first relative angle and the second relative angle.

The LiDAR may be configured to acquire a shape of the driven robot before the driven robot is docked to the driving robot, move the driving robot and the driven robot which are mechanically coupled straight forward to acquire the shape of the driven robot at a reference angle, and acquire a current shape of the driven robot, and the processor may be further configured to determine whether the shape of the driven robot at the reference angle and the current shape of the driven robot match, and calculate the first relative angle in response to determining that the shape of the driven robot at the reference angle and the current shape of the driven robot match.

The processor may be further configured to output an angle calculation fail signal in response to determining that the shape of the driven robot at the reference angle and the current shape of the driven robot do not match.

The processor may be further configured to extract a feature point of the driven robot from the rear image of the driving robot, generate depth data of the feature points of the driven robot, generate a depth map representing a depth data set according to the first relative angle by matching the first relative angle and the depth data of the feature point, and calculate a second relative angle by comparing the depth data set according to the first relative angle in the depth map with a current depth data set.

The processor may be further configured to generate the depth map in response to determining that the depth data set collected for any first relative angle is greater than or equal to a predetermined number of sets.

The processor may be further configured to output a Not Ready message in response to determining that the depth data set collected for any first relative angle is less than the predetermined number of sets.

The processor may be further configured to move the driving robot and the driven robot which are mechanically coupled straight forward and separate the feature point of the driven robot from a feature point of a surrounding environment when extracting the feature point of the driven robot from the rear image of the driving robot.

The system may further include a movement data sensor configured to detect a movement data of the driving robot and the driven robot; and an additional LiDAR configured to detect a LiDAR data of an object in front of the driving robot and in front of the driven robot. The processor may be configured to calculate a third relative angle based on a local map storing the feature point of the surrounding environment, the movement data detected by the movement data sensor, and the LiDAR data detected by the LiDAR and the additional LiDAR, and further integrate the third relative angle when calculating the final relative angle.

The processor may be further configured to obtain first absolute positions of the driving robot and the driven robot based on the LiDAR data and the local map, obtain second absolute positions of the driving robot and the driven robot based on the movement data and the local map, and calculate the third relative angle by integrating the first and second absolute positions.

The movement data sensor may include at least one of an encoder provided in the driving robot and the driven robot and configured to measure information on a rotation of a wheel; and an inertial sensor provided in the driving robot and the driven robot and configured to measure information on a movement situations of the driving robot and the driven robot.

The driving robot may be an autonomous moving robot.

According to another example of the present disclosure, a method of calculating a relative angle of a driven robot mechanically coupled to a driving robot is provided. The driven robot is capable of being mechanically coupled to a rear side of the driving robot. The method is performed by a LiDAR configured to detect a LiDAR data for the driven robot on the rear side of the driving robot, a camera configured to detect a rear image of the driving robot including the driven robot on the rear side of the driving robot, and a processor. The method includes calculating a first relative angle of the driven robot based on the LiDAR data for the driven robot; calculating a second relative angle of the driven robot based on the rear image of the driving robot including the driven robot and the first relative angle; and calculating a final relative angle by integrating the first relative angle and the second relative angle.

The calculating a first relative angle of the driven robot based on the LiDAR data for the driven robot may include acquiring a shape of the driven robot before the driven robot is docked to the driving robot; moving the driving robot and the driven robot which are mechanically coupled straight forward to acquire a shape of the driven robot at a reference angle; acquiring a current shape of a driven robot; determining whether the shape of the driven robot at the reference angle and the current shape of the driven robot match; and calculating the first relative angle in response to the determining that the shape of the driven robot at the reference angle and the current shape of the driven robot match.

The calculating a first relative angle of the driven robot based on the LiDAR data for the driven robot may further include outputting an angle calculation fail signal in response to the determining that the shape of the driven robot at the reference angle and the current shape of the driven robot do not match.

The calculating a second relative angle of the driven robot based on the rear image of the driving robot including the driven robot and the first relative angle may include extracting a feature point of the driven robot from the rear image of the driving robot; generating a depth data of the feature point of the driven robot; generating a depth map representing a depth data set according to the first relative angle by matching the first relative angle and the depth data of the feature point; and calculating a second relative angle by comparing the depth data set according to the first relative angle in the depth map with a current depth data set.

The calculating a second relative angle of the driven robot based on the rear image of the driving robot including the driven robot and the first relative angle may further include generating the depth map in response to the determining that the depth data set collected for any first relative angle is greater than or equal to a predetermined number of sets.

The calculating a second relative angle of the driven robot based on the rear image of the driving robot including the driven robot and the first relative angle may further include outputting a Not Ready message in response to determining that the depth data set collected for any first relative angle is less than a predetermined number of sets.

The extracting a feature point of the driven robot from the rear image of the driving robot may include moving the driving robot and the driven robot which are mechanically coupled straight forward and separating the feature point of the driven robot from a feature point of a surrounding environment.

The method may be further performed by a movement data sensor configured to detect a movement data of the driving robot and the driven robot, and an additional LiDAR configured to detect a LiDAR data of an object in front of the driving robot and in front of the driven robot. The method may further include calculating a third relative angle based on a local map storing a feature point of a surrounding environment, the movement data detected by the movement data sensor, and the LiDAR data detected by the LiDAR and the additional LiDAR. The calculating a final relative angle by integrating the first relative angle and the second relative angle may include calculating the final relative angle by integrating the first, second, and third relative angles.

The calculating a third relative angle based on the local map storing the feature point of the surrounding environment, the movement data detected by the movement data sensor, and the LiDAR data detected by the LiDAR and the additional LiDAR may include obtaining first absolute positions of the driving robot and the driven robot based on the LiDAR data and the local map; obtaining second absolute positions of the driving robot and the driven robot based on the movement data and the local map; and calculating the third relative angle by integrating the first and second absolute positions.

According to the present disclosure, the relative angle of the driven robot mechanically coupled to the driving robot may be calculated by using the LiDAR and the camera provided to the driving robot. By performing posture control between the driving robot and the driven robot which are mechanically coupled based on the relative angle, the driving robot and the driven robot which are mechanically coupled may not only move forward but also move backward.

In addition, if necessary, by using complementarily the relative angle of the driving robot and the driven robot calculated using map data, the relative angle of the driven robot mechanically coupled to the driving robot may be more accurately calculated.

In addition, the LiDAR and the camera provided to the driving robot capable of autonomous driving may be used to calculate the relative angle of the driven robot mechanically coupled to the driving robot. Therefore, there is no need to add a separate sensor.

Although the preferred examples of the present disclosure have been described above, the present disclosure is not limited to the above examples, and includes all changes within the range that is easily changed and recognized as equivalent by those skilled in the art from the examples of the present disclosure.

What is claimed is:

1. A system for controlling driving of a first robot, the system comprising:
the first robot configured to drive a second robot, wherein a rear side of the first robot is configured to be mechanically coupled to the second robot;
a first sensor configured to obtain sensor data for the second robot coupled to the rear side of the first robot;
a second sensor configured to obtain a rear view image from the first robot, wherein the rear view image comprises an image of the second robot coupled to the rear side of the first robot; and
a processor configured to:
determine, based on the sensor data, a first angle between the first robot and the second robot,
determine, based on the rear view image, a second angle between the first robot and the second robot,
determine, based on the first angle and the second angle, a third angle between the first robot and the second robot,
output a signal associated with the third angle, and
control, based on the signal, the driving of the first robot.

2. The system of claim 1, wherein:
the first sensor is configured to:
acquire a shape of the second robot before the second robot is coupled to the first robot, and
acquire a current shape of the second robot; and
the processor is further configured to:
move the first robot and the second robot straight forward to acquire a second shape of the second robot at a reference angle,
determine whether the second shape of the second robot at the reference angle and the current shape of the second robot match, and
determine, based on the shape of the second robot at the reference angle and the current shape of the second robot matching, the first angle.

3. The system of claim 2, wherein the processor is further configured to output, based on the second shape of the second robot at the reference angle and the current shape of the second robot not matching, a signal indicating an angle determination failure.

4. The system of claim 1, wherein the processor is further configured to:
extract a feature point of the second robot from the rear view image,
generate depth data of the feature point of the second robot,
generate a depth map representing a depth data set based on the first angle by matching the first angle and the depth data of the feature point, and
determine the second angle by comparing the depth data set with a current depth data set.

5. The system of claim 4, wherein the processor is further configured to generate the depth map based on a number of the depth data set being greater than or equal to a threshold number of sets, and wherein the depth data set is collected for any initial angle.

6. The system of claim 5, wherein the processor is further configured to output a Not Ready message based on the number of the depth data set being less than the threshold number of sets.

7. The system of claim 4, wherein the processor is further configured to:
move the first robot and the second robot straight forward, and
separate the feature point of the second robot from a feature point of a surrounding environment of the second robot based on extracting the feature point of the second robot from the rear view image.

8. The system of claim 1, further comprising:
a third sensor configured to obtain a movement data of the first robot and the second robot; and
a fourth sensor configured to obtain sensor data of an object in front of the first robot and the second robot,
wherein the processor is configured to:
determine a fourth angle between the first robot and the second robot based on:
a local map storing a feature point of a surrounding environment,
the movement data,
the sensor data for the second robot, and
the sensor data of the object; and
determine, based on the fourth angle and the third angle, a final angle.

9. The system of claim 8, wherein the processor is further configured to:
obtain first absolute positions of the first robot and the second robot based on the sensor data for the second robot and the local map,
obtain second absolute positions of the first robot and the second robot based on the movement data and the local map, and
determine, based on the first absolute positions and the second absolute positions, the fourth angle.

10. The system of claim 8, wherein the third sensor comprises at least one of:
an encoder provided in the first robot and the second robot and configured to measure information on a rotation of a wheel; and
an inertial sensor provided in the first robot and the second robot and configured to measure information on a movement situation of the first robot and the second robot.

11. The system of claim 1, wherein:
the first robot is an autonomous moving robot.

12. A method performed by a system for controlling driving of a first robot, the method comprising:
obtaining, from a first sensor, a sensor data for a second robot mechanically coupled to a rear side of the first robot;
obtaining, from a second sensor, a rear view image from the first robot, wherein the rear view image comprises an image of the second robot coupled to the rear side of the first robot;
determining, based on the sensor data, a first angle between the first robot and the second robot;
determining, based on the rear view image, a second angle between the first robot and the second robot;
determining, based on the first angle and the second angle, a third angle between the first robot and the second robot;
outputting a signal associated with the third angle; and
controlling, based on the signal, driving of the first robot.

13. The method of claim 12, wherein the determining the first angle comprises:
acquiring a shape of the second robot before the second robot is coupled to the first robot;
moving the first robot and the second robot straight forward to acquire a second shape of the second robot at a reference angle;
acquiring a current shape of the second robot;
determining whether the second shape of the second robot at the reference angle and the current shape of the second robot match; and
determining, based on the second shape of the second robot at the reference angle and the current shape of the second robot matching, the first angle.

14. The method of claim 13, wherein the determining the first angle comprises:
outputting, based on the second shape of the second robot at the reference angle and the current shape of the second robot not matching, a signal indicating an angle determination failure.

15. The method of claim 12, wherein the determining the second angle comprises:
extracting a feature point of the second robot from the rear view image;
generating a depth data of the feature point of the second robot;
generating a depth map representing a depth data set based on the first angle by matching the first angle and the depth data of the feature point; and
determining the second angle by comparing the depth data set with a current depth data set.

16. The method of claim 15, wherein the determining the second angle comprises:
generating the depth map based on a number of the depth data set being greater than or equal to a threshold number of sets, and wherein the depth data set is collected for any initial angle.

17. The method of claim 15, wherein the determining the second angle comprises:
outputting a Not Ready message based on a number of the depth data set being less than a threshold number of sets, and wherein the depth data set is collected for any initial angle.

18. The method of claim 15, wherein the extracting the feature point comprises:
moving the first robot and the second robot straight forward; and
separating the feature point of the second robot from a feature point of a surrounding environment of the second robot.

19. The method of claim 12, further comprising:
obtaining, from a third sensor, a movement data of the first robot and the second robot;
obtaining, from a fourth sensor, sensor data of an object in front of the first robot and the second robot;
determining a fourth angle between the first robot and the second robot based on:
a local map storing a feature point of a surrounding environment,
the movement data,
the sensor data for the second robot, and
the sensor data of the object; and
determining, based on the fourth angle and the third angle, a final angle.

20. The method of claim 19, wherein the determining the fourth angle comprises:
obtaining first absolute positions of the first robot and the second robot based on the sensor data for the second robot and the local map;
obtaining second absolute positions of the first robot and the second robot based on the movement data and the local map; and
determining, based on the first absolute positions and the second absolute positions, the fourth angle.
